(19) United States
(12) Patent Application Publication
(10) Pub. No.: US 2015/0248216 A1
(43) Pub. Date: Sep. 3, 2015

(54) INFORMATION INTERFACE GENERATION AND/OR POPULATION

(71) Applicant: Microsoft Technology Licensing, LLC, Redmond, WA (US)

(72) Inventors: Yi Li, Issaquah, WA (US); Yu-Ting Kuo, Sammamish, WA (US); Gaurav Anand, Seattle, WA (US); Ting Cai, Redmond, WA (US); Catalin Teodor Milos, Bellevue, WA (US); Wei Wei, Redmond, WA (US)

(73) Assignee: Microsoft Corporation, Redmond, WA (US)

(21) Appl. No.: 14/193,519

(22) Filed: Feb. 28, 2014

(51) Int. Cl. G06F 3/0484; G06F 17/30; H04L 29/08; G06F 3/0482

(52) U.S. Cl. CPC G06F 3/04842; G06F 3/0482; G06F 17/30867; G06F 17/30876; H04L 67/306

(57) ABSTRACT

One or more techniques and/or systems are provided for generating an information interface. For example, a user signal associated with a user may be identified (e.g., an email about a videogame console reservation, the user selecting a videogame review section of a shopping website, etc.). The user signal may be evaluated to determine a user interest of the user (e.g., a videogame user interest). A content provider that provides content associated with the user interest may be identified (e.g., a videogame magazine website). An information interface may be generated for the user interest (e.g., a dynamically created app, an operating system user interface such as a tile, etc.), and may be populated with content from the content provider (e.g., videogame images, reviews, trailers, and/or other content may be populated within the information interface). The information interface may be dynamically updated based upon a content update provided by the content provider.

### BACKGROUND

Users may follow various information, such as weather, stock prices, product pricing, celebrity news, concert tickets, and/or a wide variety of other information. A user may visit websites, subscribe to news feeds, follow microblogging users, subscribe to email lists, and/or perform other tasks to tracking information. In an example, the user may search for vacation information through a web search interface. The user may bookmark a website so that the user may remember and/or later return to the website. For example, the user may bookmark a vacation broker webpage, a resort social network profile webpage, a vacation photo search results page, etc.

### SUMMARY

This summary is provided to introduce a selection of concepts in a simplified form that are further described below in the detailed description. This summary is not intended to identify key factors or essential features of the claimed subject matter, nor is it intended to be used to limit the scope of the claimed subject matter.

Among other things, one or more systems and/or techniques for generating an information interface based upon a user interest are provided herein. In an example, a user signal associated with a user may be identified. The user signal may be evaluated to determine a user interest of the user. In an example, a videogame review application, installed on a device associated with the user, may be identified as a videogame user signal used to identify a videogame user interest. In another example, the user may befriend a national park entity through a social network, which may be identified as a national park user signal used to identify a hiking user interest, a park user interest, a nature user interest, and/or other user interests for the user. In this way, various signals (e.g., an email, a message, a device location, a social network profile, a browsing history, a user specified user interest such as a selection of a celebrity gossip section of a webpage, etc.) may be evaluated to determine user interests of the user.

A content provider that provides content associated with the user interest may be identified. For example, a videogame company social network profile may be identified as a first content provider and a videogame website may be identified as a second content provider for the videogame user interest. An information interface may be generated for the user interest, and may be populated with content from the content provider. In an example, the information interface may be generated as a standalone application (e.g., an application may be dynamically generated for displaying content from the content provider). In another example, the information interface may be populated within an information application configured to display a plurality of information interfaces. In another example, the information interface may be populated within an operating system interface (e.g., operating system tile). The information interface may be updated based upon content updates provided by the content provider. For example, the videogame website may be evaluated to identify a new videogame review as a content update that may be used to update the information interface with the new videogame review. In this way, the information interface may be dynamically updated with content from various content providers (e.g., in a manner that may be transparent to content providers).

In an example, an interface management component, configured for generating an information interface, may be implemented on a client device. For example, the interface management component may retrieve content from a remote content provider (e.g., from a search engine server), and the interface management component may locally generate the information interface on the client device (e.g., dynamically create an app on the client device; display the information interface through an operating system interface; etc.). In another example, the interface management component may be implemented on a server that is remote from the client device (e.g., the interface management component may remotely generate the information interface, and may send the information interface to one or more client devices for display).

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating an information interface based upon a user interest.

FIG. 2A is an illustration of an example of identifying user interests of a user.

FIG. 2B is an illustration of an example of determining a theatre show user interest of a user.

FIG. 3A is a component block diagram illustrating an exemplary system for evaluating a user signal to identify a user interface of a user.

FIG. 3B is a component block diagram illustrating an exemplary system for identifying content providers that provide content used to populate an information interface.

FIG. 3C is a component block diagram illustrating an exemplary system for exposing a configuration interface for configuring an information interface.

FIG. 3D is a component block diagram illustrating an exemplary system for generating an information interface based upon a user interest of a user.

FIG. 3E is a component block diagram illustrating an exemplary system for updating an information interface.

FIG. 4A is an illustration of an example of selectively providing information interfaces to devices associated with a user.

FIG. 4B is an illustration of an example of updating user interests of a user based upon user feedback corresponding to user interaction with content provided through information interfaces.

FIG. 5 is an illustration of an example of sharing an information interface.

FIG. 6 is an illustration of an exemplary computer readable medium wherein processor-executable instructions configured to embody one or more of the provisions set forth herein may be comprised.

FIG. 7 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth to provide an understanding of the claimed subject matter. It may be evident, however, that the claimed subject matter may be practiced without these specific details. In other instances, structures and devices are illustrated in block diagram form in order to facilitate describing the claimed subject matter.

One or more techniques and/or systems for generating an information interface based upon a user interest are provided. In an example, various user signals (e.g., an email regarding a home purchase, a current location of a user such as at a hockey game, a browsing history, a user selection of a running section of an exercise webpage, etc.) may be evaluated to determine a user interest, such as an interest in a webpage (e.g., a realtor webpage), entities (e.g., a hockey team), topics (e.g., running), and/or other user interest. A content provider, such as a website, may be identified as providing content associated with the user interest. An information interface may be generated for the user interest (e.g., a visual interface that may display imagery, text, and/or functionality extracted from content of the content provider). The information interface may be populated with the content from the content provider, and may be dynamically updated based upon content updates provided by the content provider (e.g., a website or social network profile may be evaluated to determine whether content has changed). In this way, an information interface may be dynamically generated and/or refreshed with up-to-date content that may be interesting and/or relevant to a user.

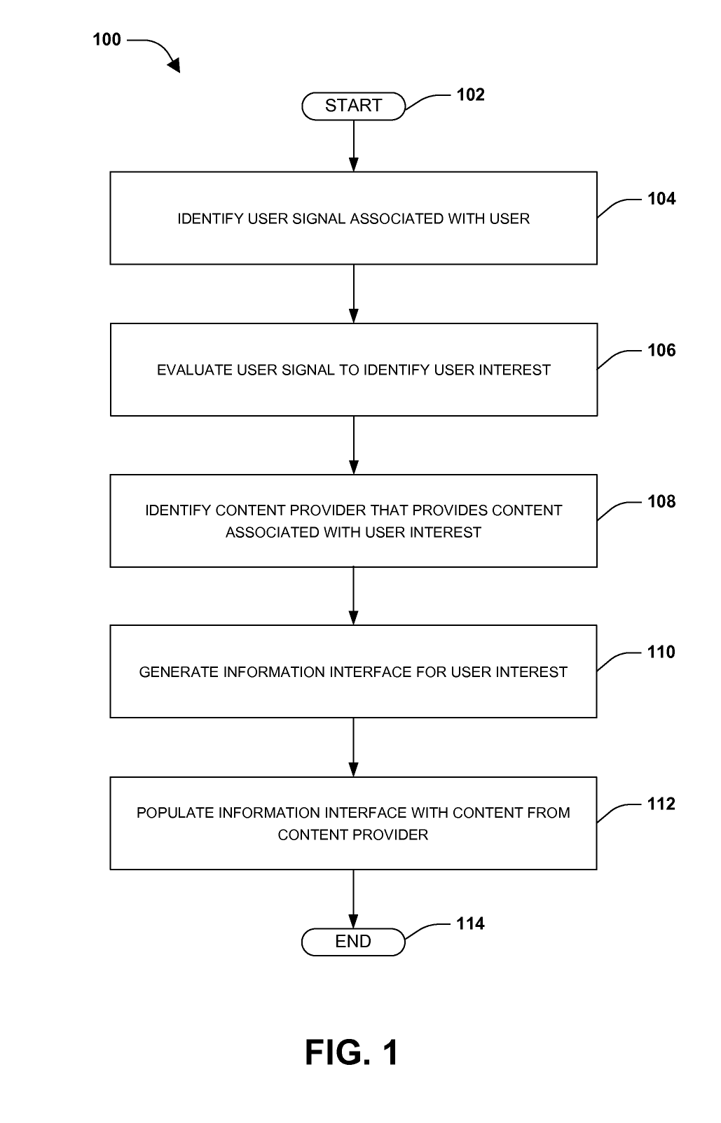

An embodiment of generating an information interface based upon a user interest is illustrated by an exemplary method 100 of FIG. 1. At 102, the method starts. At 104, a user signal associated with a user may be identified (e.g., an email, a social network profile, a calendar entry, a message, a device location such as a user visiting a videogame store, user data stored on a user device such as a videogame reservation ticket, an app hosted by a user device such as a videogame review app, a browsing history, etc.). In an example, the user signal may comprise a user selected field of a webpage (e.g., a user may perform a selection gesture to select a videogame review section of a shopping website). In another example, a set of pre-generated information interfaces may be exposed for user browsing (e.g., a visual browsing interface may display a wide variety of pre-generated information interfaces for exploration and/or discovery by users), and the user signal may be identified as a selection of a pre-generated information interface. In another example, responsive to identifying user input associated with a search query, a set of search query suggestion pre-generated information interfaces may be suggested to the user, such that the user signal may be identified as a selection of a search query suggestion pre-generated information interface. In another example, a set of search result pre-generated information interfaces may be exposed in response to a user query through an information interface search engine, such that the user signal may be identified as a selection of a search result pre-generated information interface. In this way, one or more user signals associated with the user may be identified.

At 106, the user signal may be evaluated to determine a user interest of the user. For example, a videogame interest may be identified based upon the videogame reservation ticket, the user visiting the videogame store, and the videogame review app. In an example, the user signal may be evaluated to identify a relationship between the user interest and a second user interest (e.g., action movies). In this way, one or more user interests may be identified for the user. At 108, a content provider that provides content associated with the user interest may be identified. For example, a website for the videogame store, a videogame magazine website, and a videogame company social network profile may be identified as content providers. In an example, a user interest to URL mapping may be generated. The user interest to URL mapping may map user interests to URLs associated with content providers (e.g., the user interest to URL mapping may be queried with a user interest, associated with an information interface, to identify a content provider that provides content that may be used to populate and/or update the information interface).

At 110, the information interface may be generated for the user interest. In an example, a set of pre-generated information interfaces may be exposed to the user. The set of pre-generated information interfaces may comprise a first pre-generated information interface associated with a first content type (e.g., videogame review videos) and a second pre-generated information interface associated with a second content type (e.g., videogame purchasing functionality). In this way, the user may select a pre-generated information interface as the information interface. In another example, the information interface may be generated as a standalone application (e.g., an application may be dynamically generated to display content from the content provider). In another example, the information interface may be populated within an information application configured to display a plurality of information interfaces. In another example, the information interface may be populated within an operating system interface (e.g., operating system tile). In this way, the information interface may be displayed through an operating system interface, an application, and/or a website.

In an example, a configuration interface may be exposed to the user. A user configuration for the information interface may be received through the configuration interface. For example, the user configuration may specify a category for categorizing the information interface (e.g., a gaming category), a selected sample layout (e.g., what content to display and/or how such content is to be displayed), a content update frequency (e.g., an interval within which to check the content provider for content updates), a location of the user (e.g., used to identify a local videogame store), a user interface property (e.g., size, color, font, etc.). In this way, the user configuration may be applied to the information interface.

At 112, the information interface may be populated with content from the content provider. For example, a videogame review may be extracted from the videogame magazine website, and displayed through the information interface. In an example, the information interface may be populated with second content from a second content provider (e.g., pricing information from the local videogame store). The information interface may be updated based upon content updates for the content provided by the content provider. In an example, a refresh request may be received for the information interface (e.g., based upon expiration of a refresh timer configured according to the content update frequency). The user interest to URL mapping may be evaluated to identify a videogame magazine webpage as the content provider for the videogame user interest. A current version of the videogame magazine webpage may be retrieved (e.g., a snapshot of the videogame magazine webpage, a textual recognition and/or image recognition of the videogame magazine webpage, a markup and code evaluation of the videogame magazine webpage, etc.). A field of the webpage (e.g., a videogame review section of the videogame magazine website) may be evaluated to identify a content update for the information interface (e.g., a new videogame review may be identified within the videogame review section). The information interface may be updated based upon the content update (e.g., the information interface may be populated with the new videogame review). In this way, the information interface may be dynamically updated with up-to-date content that may be relevant and/or interesting to the user.

In an example, the user may be associated with a first device having a first device type (e.g., a laptop), a second device having a second device type (e.g., a smartphone), and/or other devices. The information interface may be selectively provided to the first device based upon the first device type, but not provided to the second device (e.g., a videogame information interface may be provided to the laptop, but not the smartphone due to processing and/or resolution limitations of the smartphone). A second information interface may be provided to the second device based upon the second device type, but not provided to the first device (e.g., a microblog information interface (e.g., displaying tweets) may be provided to the smartphone but not the laptop due to the user generally having more immediate access to the smartphone).

In an example of generating an information interface, a user may access a webpage. The user may select one or more fields within the webpage (e.g., the user may perform a selection gesture to select a camera review section of a shopping webpage). Labels may be determined for the one or more fields. In an example, a user specified label may be received for a first field as a first label (e.g., the user may specify a “camera rating” label for a numerical rating field used for displaying ratings of cameras). In another example, content of a second field may be evaluated to identify a second label (e.g., image recognition functionality may be used to identify a camera label for an image field depicting a camera). A user interest may be determined based upon one or more fields and/or labels (e.g., a consumer electronic user interest; a camera shopping user interest; etc.). An information interface may be generated and/or populated with content corresponding to the field (e.g., a camera review may be populated within the information interface). The content may be identified by the label (e.g., the camera review may be labeled as “camera rating”). The webpage may be periodically evaluated for content updates that may be used to update the information interface.

Information interfaces may be shared between users. In an example, responsive to receiving a share request for the information interface from the user, the information interface may be shared with a second user (e.g., the user may want to share camera ideas with a friend). In another example, a shared information interface may be received from the second user. The user may be provided with a suggestion of the shared information interface. Responsive to receiving a selection of the suggestion, an instance of the information interface (e.g., a second information interface) may be generated for the user based upon the shared information interface. The user may specify a user configuration for the second information interface so that the second information interface may be personalized for the user (e.g., and thus may be different than the shared information interface of the second user).

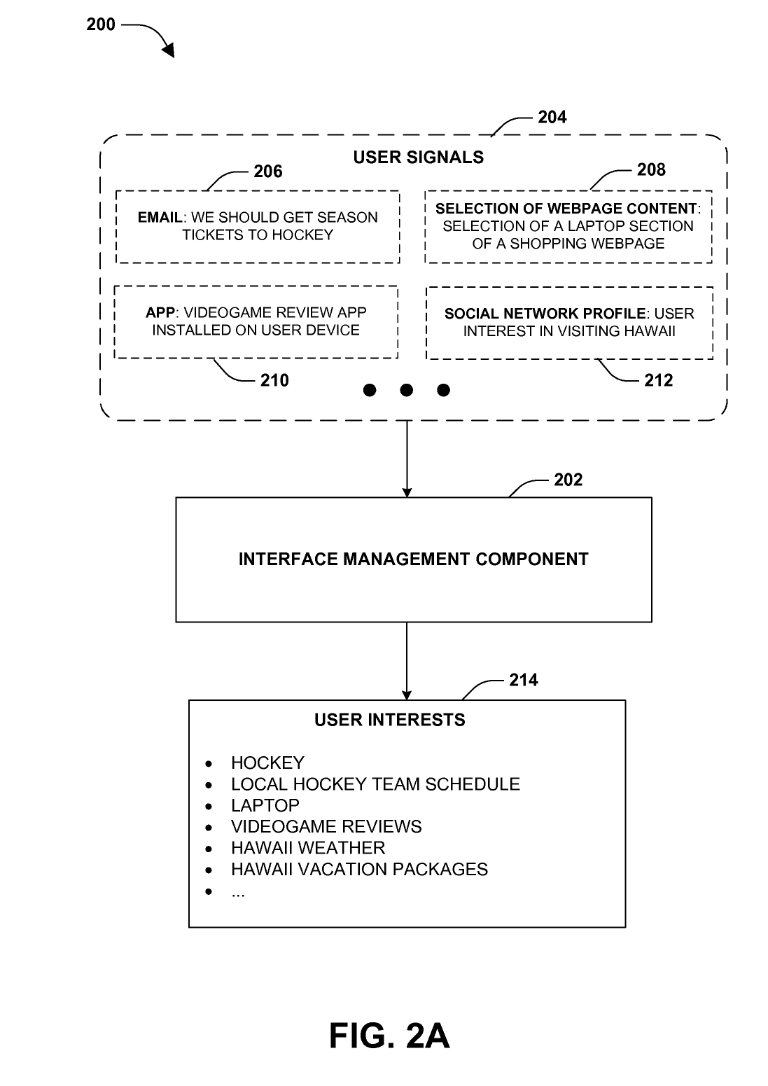

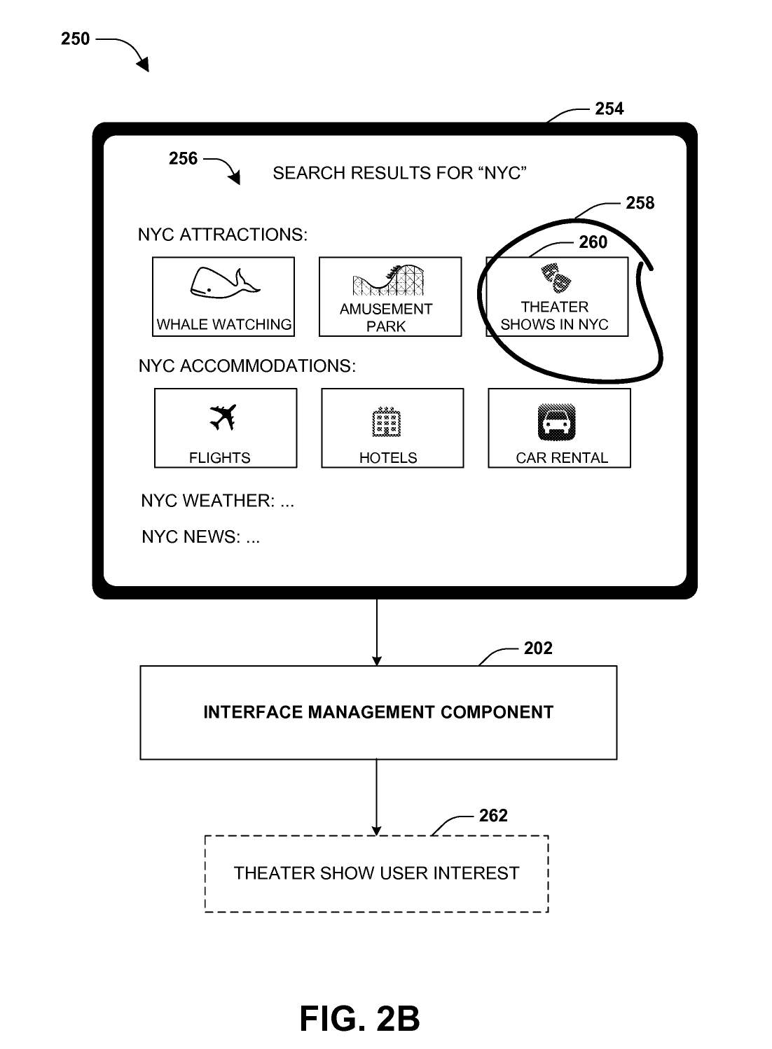

FIG. 2A illustrates an example 200 of identifying user interests 214 of a user. An interface management component 202 may be configured to identify user signals 204 associated with the user. For example, an email 206 may indicate that the user desires to get hockey season tickets. A selection of webpage content 208 by the user may indicate that the user desires to track laptop information of a shopping webpage. A videogame review app 210 installed on a device associated with the user may indicate that the user has an interest in videogames. A social network profile 212 may indicate that the user has an interest in visiting Hawaii. In this way, the interface management component 202 may identify various user signals 204. The interface management component 202 may evaluate the user signals 204 to identify the user interests 214 of the user, such as a hockey interest, a local hockey team schedule interest, a laptop interest, a videogame reviews interest, a Hawaii weather interest, a Hawaii vacation packages interest, and/or other interests.

FIG. 2B illustrates an example 250 of determining a theatre show user interest 262 of the user. The user may submit a search query “NYC” through a device 254. A search results page 256 may be provided to the user based upon the search query “NYC”. The search results page 256 may comprise a whale watching section, an amusement park section, a theater shows section 260, and/or a variety of other search results. The interface management component 202 may identify a user selection 258 of the theatre shows section 260 as a user signal. The interface management component 202 may evaluate the theatre shows section 260 (e.g., a user label specified for the theatre shows section 260, a textual recognition result for the theatre shows section 260, an image recognition result for the theatre shows section 260, etc.) to determine the theatre show interest 262 of the user.

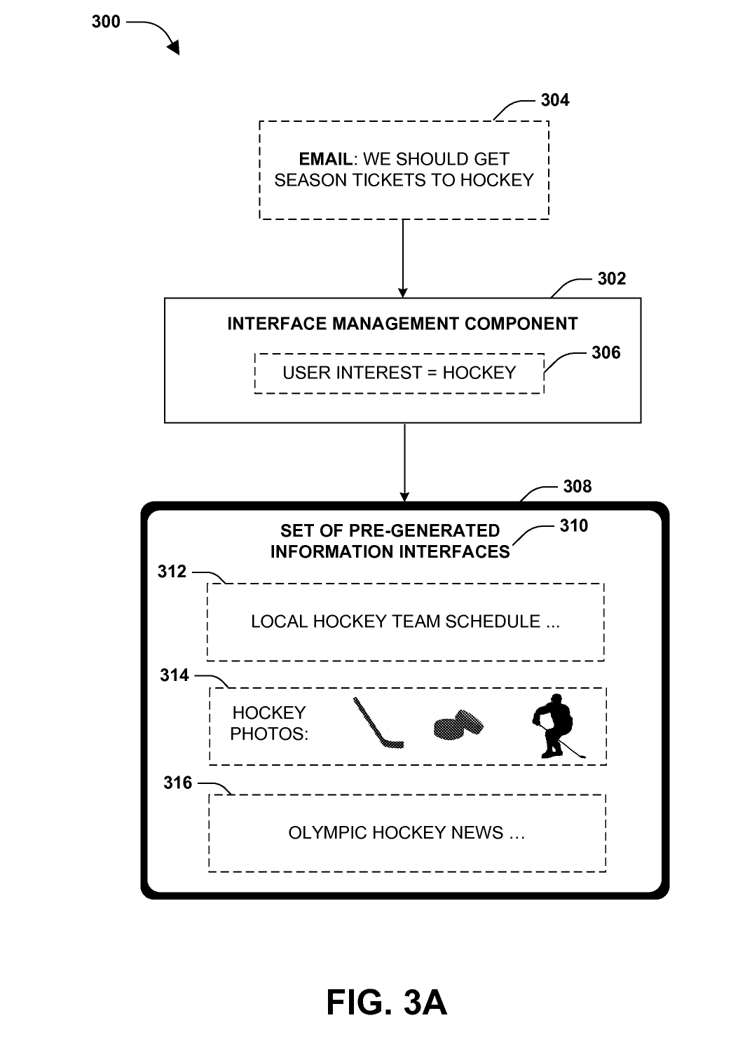

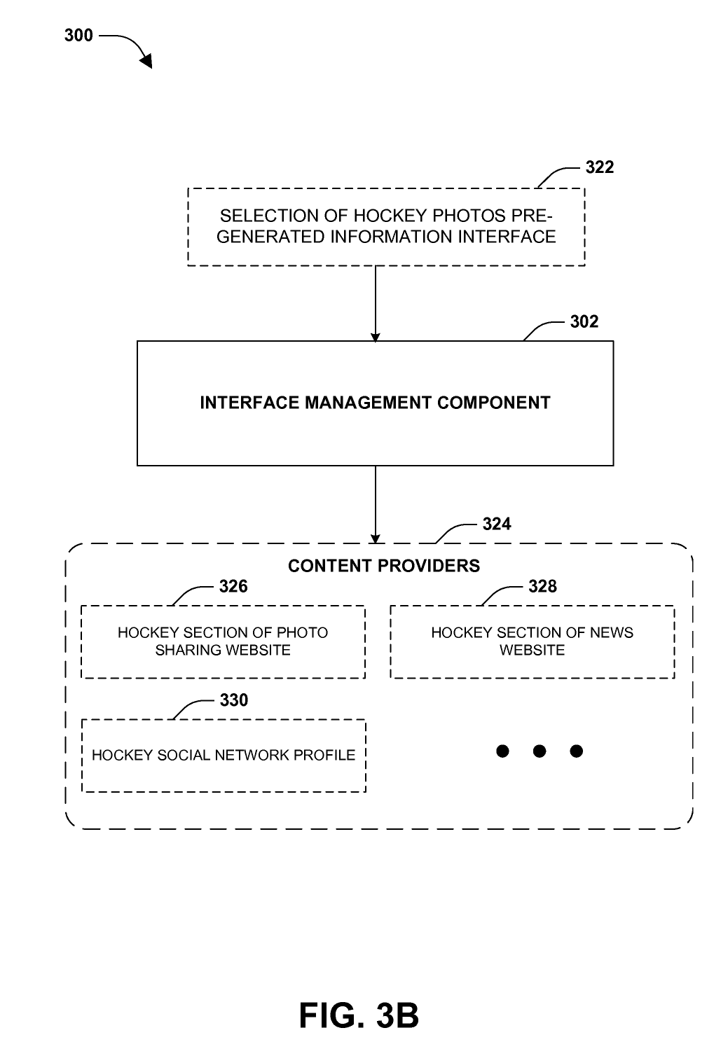

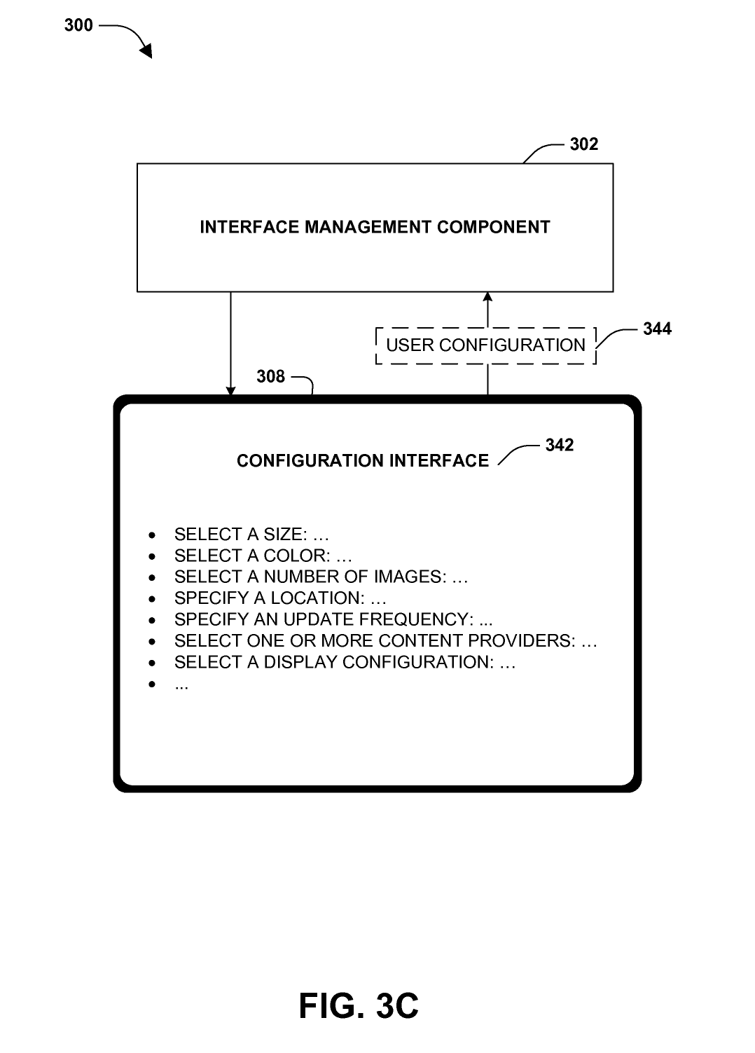

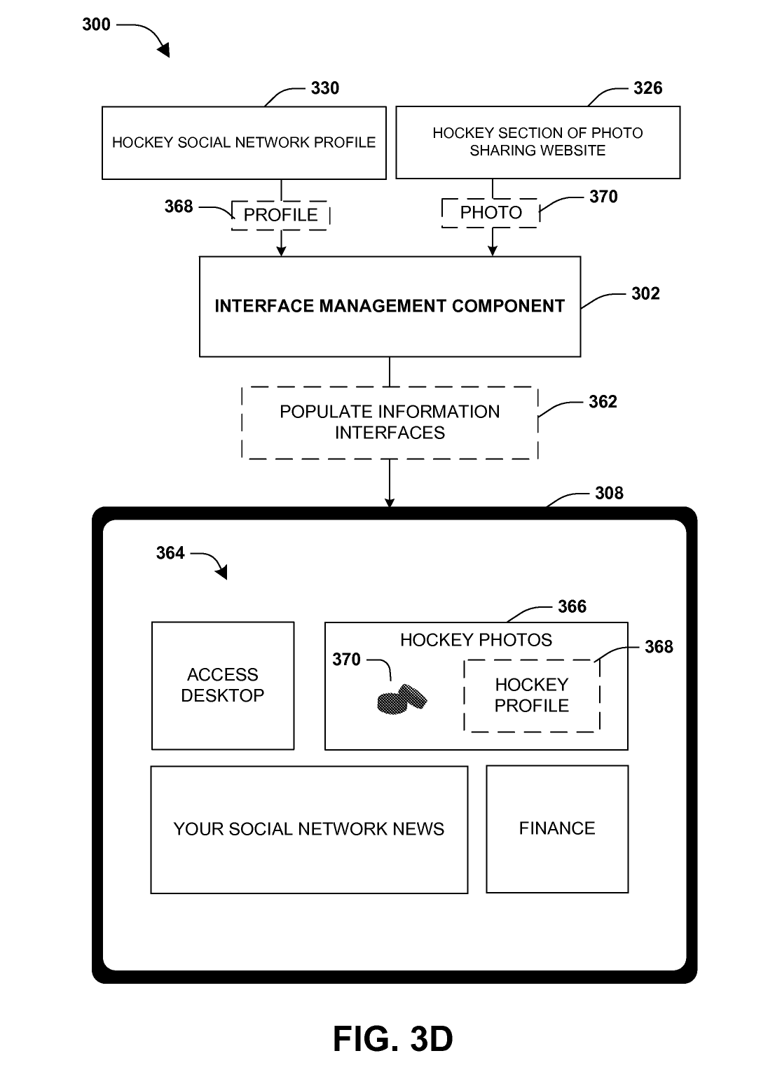

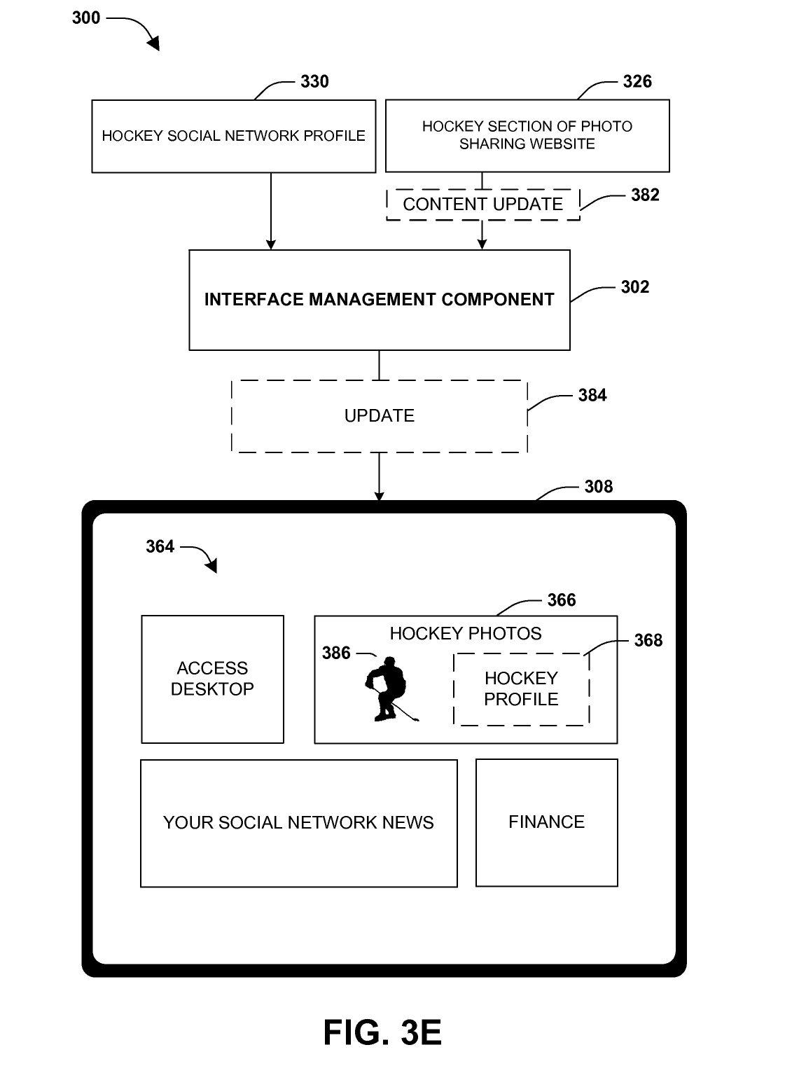

FIGS. 3A-3E illustrate an example of a system 300 for generating an information interface based upon a user interest of a user. The system 300 comprises an interface management component 302. The interface management component 302 may identify an email 304 as a user signal associated with the user, as illustrated by FIG. 3A. The email 304 may be evaluated (e.g., using a textual recognition technique) to determine a hockey user interest 306 for the user. In an example, the interface management component 302 may identify and/or create a set of pre-generated information interfaces 310 associated with the hockey user interest 306. The set of pre-generated information interfaces 310 may comprise a local hockey team schedule pre-generated information interface 312, a hockey photos pre-generated information interface 314, an Olympics hockey news pre-generated information interface 316, and/or other pre-generated information interfaces. The interface management component 302 may present the set of pre-generated information interface 310 through a device 308 associated with the user so that the user may select a pre-generated information interface as a template for generating an information interface.

The interface management component 302 may identify a selection 322 of the hockey photos pre-generated information interface 314, as illustrated in FIG. 3B. The interface management component 302 may utilize the hockey photos pre-generated information interface 314 as a template for generating a hockey photos information interface. The interface management component 302 may identify one or more content providers 324 that provide content associated with the hockey user interest 306 corresponding to the hockey photos pre-generated information interface 314 selected by the user. For example, a first content provider 326 may correspond to a hockey section of a photo sharing website, a second content provider 328 may correspond to a hockey section of a news website, a third content provider 330 may correspond to a hockey social network profile, and/or other content providers that may provide hockey content. In an example, the interface management component 302 and/or the user may select one or more of the content providers 324 to use as providers of content for populating the hockey photos information interface.

The interface management component 302 may expose a configuration interface 342 to the user, as illustrated in FIG. 3C. The user may configure various aspects of the hockey photos information interface, such as size (e.g., a number of operating system tiles across which content is to be displayed), a color, a number of images with which to populate the hockey photos information interface, a location of the user (e.g., used to identify local hockey content relevant to the user), an update frequency with which to check content providers for content updates, a selection of one or more content providers from the content providers 324, a display configuration, one or more devices with which to associate the hockey photos information interface, and/or a wide variety of other configuration information. In this way, a user configuration 344 may be received through the configuration interface 342.

The interface management component 302 may generate a hockey photos information interface 366 for display through the device 308, as illustrated in FIG. 3D. In an example, the interface management component 302 may display the hockey photos information interface 366 as an operating system interface (e.g., a tile of an operating system homepage 364). The interface management component 302 may extract hockey profile content 368 from the third content provider 330 (e.g., the hockey social network profile) and hockey puck photo content 370 from the first content provider 326 (e.g., the hockey section of the photo sharing website). The interface management component 302 may populate 362 the hockey photos information interface 366 with the hockey profile content 368 and/or the hockey puck photo content 370. In this way, content that may be relevant and/or of interest to the user may be surfaced and presented to the user in an automated fashion (e.g., in a manner that may be transparent to content providers).

The interface management component 302 may be configured to identify a content update provided by a content provider, as illustrated in FIG. 3E. In an example, the interface management component 302 may identify a content update 382 provided by the first content provider 326. For example, the interface management component 302 may receive a refresh request for the hockey photos information interface 366 (e.g., based upon an expiration of a refresh timer). The interface management component 302 may evaluate a user interest to URL mapping to identify the first content provider 326 (e.g., the hockey section of the photo sharing website) as providing content for the hockey user interest 306 associated with the hockey photos information interface 366. The interface management component 302 may retrieve a current version of the hockey section (e.g., a snapshot of the hockey section), and may evaluate one or more fields of the hockey section (e.g., a daily hockey photo field comprising hockey player photo content 386) to identify the content update 382 for the hockey section 326. For example, the content update 382 may corresponds to the hockey player photo content 386 that is different than a previous daily hockey photo (e.g., the hockey puck photo content 370 of FIG. 3D) currently used to populate the hockey photos information interface 366. Accordingly, the interface management component 302 may update 384 the hockey photos information interface 366 with hockey player photo content 386 based upon the content update 382.

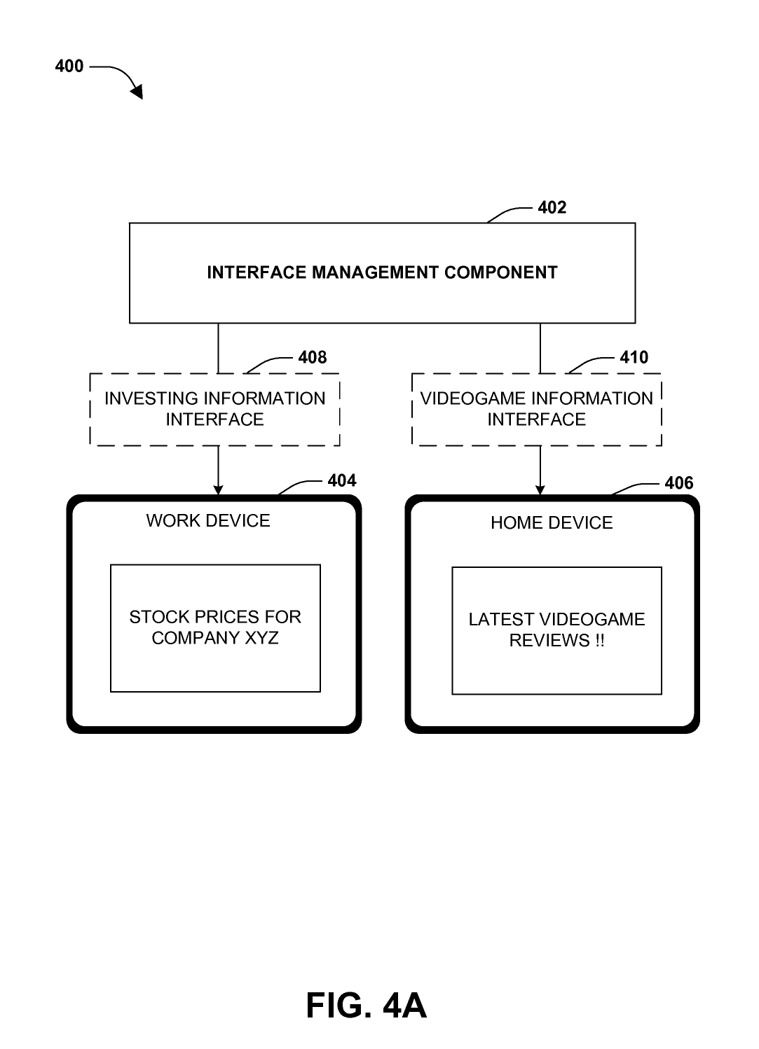

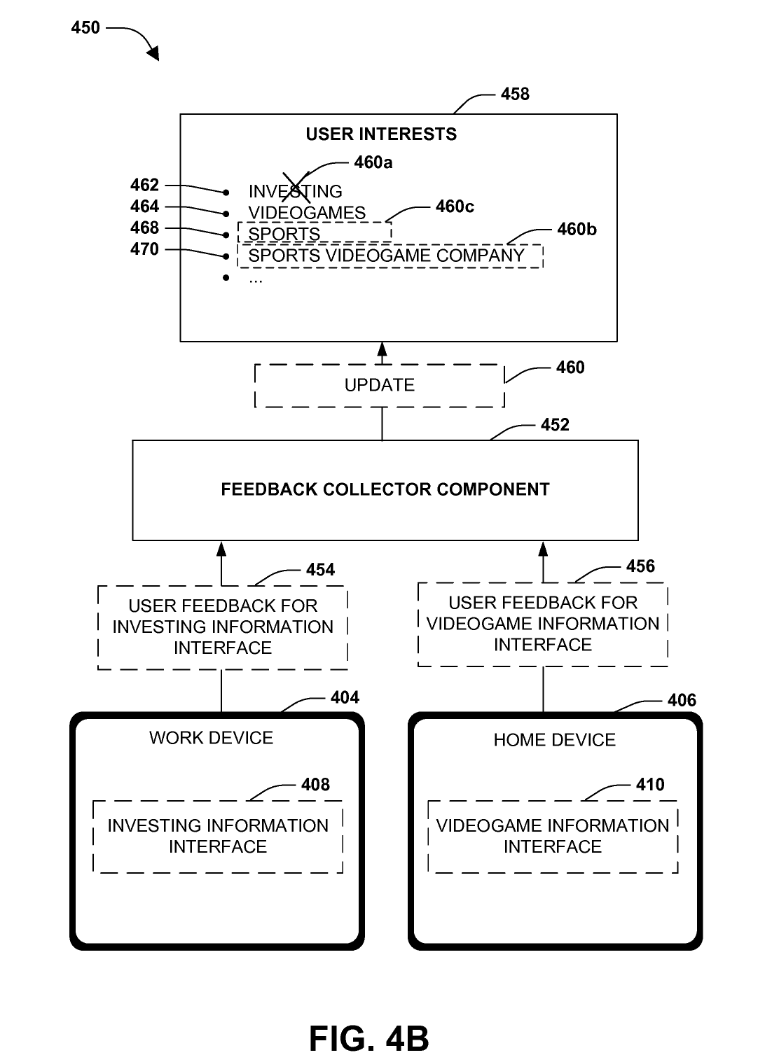

FIG. 4A illustrates an example 400 of selectively providing information interfaces to devices associated with a user. An interface management component 402 may have generated an investing information interface 408 for the user based upon a user signal indicating that the user has an investing user interest (e.g., an email may indicate that the user is considering buying stock for Company XYZ). The interface management component 402 may have generated a videogame information interface 410 for the user based upon a user signal indicating that the user has a videogame user interest (e.g., the user may have subscribed to a videogame company microblog). The user may specify that the videogame information interface 410 is to be provided to a home device 406, such as a personal tablet device, but not to a work device 404, such as a company laptop. The user may specify that the investing information interface 408 is to be provided to the work device 404, but not to the home device 406. In this way, information interfaces may be selectively provided to devices.

FIG. 4B illustrates an example 450 of updating user interests 458 of a user based upon user feedback corresponding to user interaction with content provided through information interfaces. In an example, an interface management component 402 may have provided an investing information interface 408 to a work device 404 and a videogame information interface 410 to a home device 406 of the user based upon an investing user interest and a videogames user interest of the user, as illustrated in example 400 of FIG. 4A. A feedback collector component 452 may be configured to collect user feedback corresponding to how the user interacted with content provided through the information interfaces. For example, user feedback 454 for the investing information interface 408 may indicate that the user merely interacted with a sports videogame company investing profile but no other investing content provided through the investing information interface 408. User feedback 456 for the videogame information interface 456 may indicate that the user interacted with a variety of sports content, such as sports videogame content, provided through the videogame information interface 456. Accordingly, the feedback collector component 452 may remove 460a the investing user interest 462 and add 460b a new sports videogame company user interest 470 to the user interests 458 because the user feedback 454 for the investing information interface 408 indicated that the user had an interest in the sports videogame company but seemed to lack an interest in other investing content. The feedback collector component 452 may add 460c a new sports user interest 468 to the user interests 458 because the user feedback 456 for the videogame information interface 410 indicated that the user interacted with a threshold amount of sports content provided through the videogame information interface 410. The feedback collector component 452 may leave the videogames user interest 464 within the user interests 458 because the user interactions indicated a sufficient continued interest in videogames.

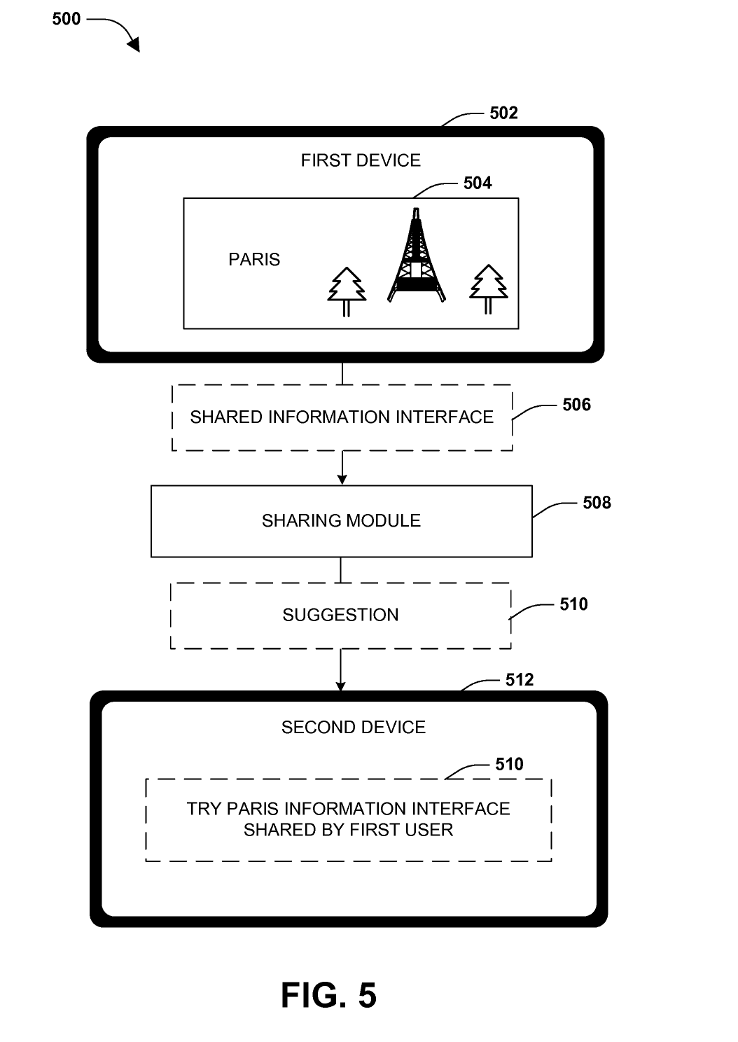

FIG. 5 illustrates an example of a system 500 for sharing an information interface. The system 500 may comprise a sharing module 508 associated with a first device 502 of a first user and/or a second device 512 of a second user. The sharing module 508 may receive a shared information interface 506 from the first device 502. For example, the shared information interface 506 may correspond to a Paris information interface 504 that the first user may desire to share with the second user. The sharing module 508 may provide a suggestion 510 of the shared information interface 506 to the second device 512. Responsive to the second user selecting the suggestion 510, a second information interface may be generated for the second device 512. In this way, users may share information interfaces.

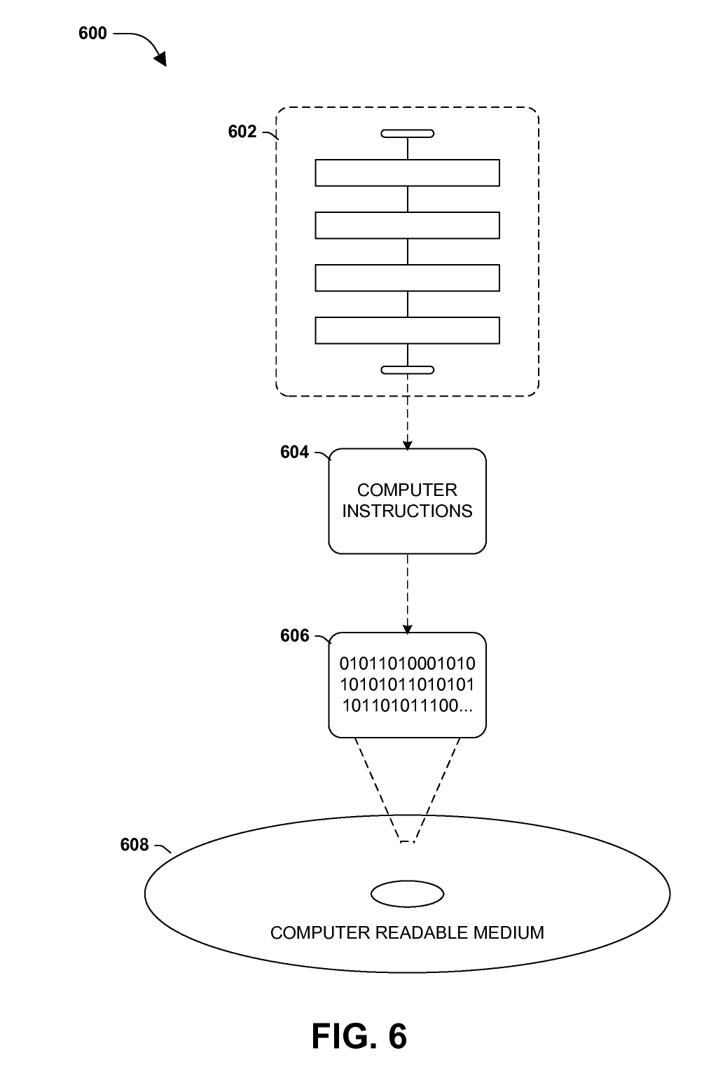

Still another embodiment involves a computer-readable medium comprising processor-executable instructions configured to implement one or more of the techniques presented herein. An example embodiment of a computer-readable medium or a computer-readable device is illustrated in FIG. 6, wherein the implementation 600 comprises a computer-readable medium 608, such as a CD-R, DVD-R, flash drive, a platter of a hard disk drive, etc., on which is encoded computer-readable data 606. This computer-readable data 606, such as binary data comprising at least one of a zero or a one, in turn comprises a set of computer instructions 604 configured to operate according to one or more of the principles set forth herein. In some embodiments, the processor-executable computer instructions 604 are configured to perform a method 602, such as at least some of the exemplary method 100 of FIG. 1, for example. In some embodiments, the processor-executable instructions 604 are configured to implement a system, such as at least some of the exemplary system 300 of FIG. 3, for example. Many such computer-readable media are devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

As used in this application, the terms “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

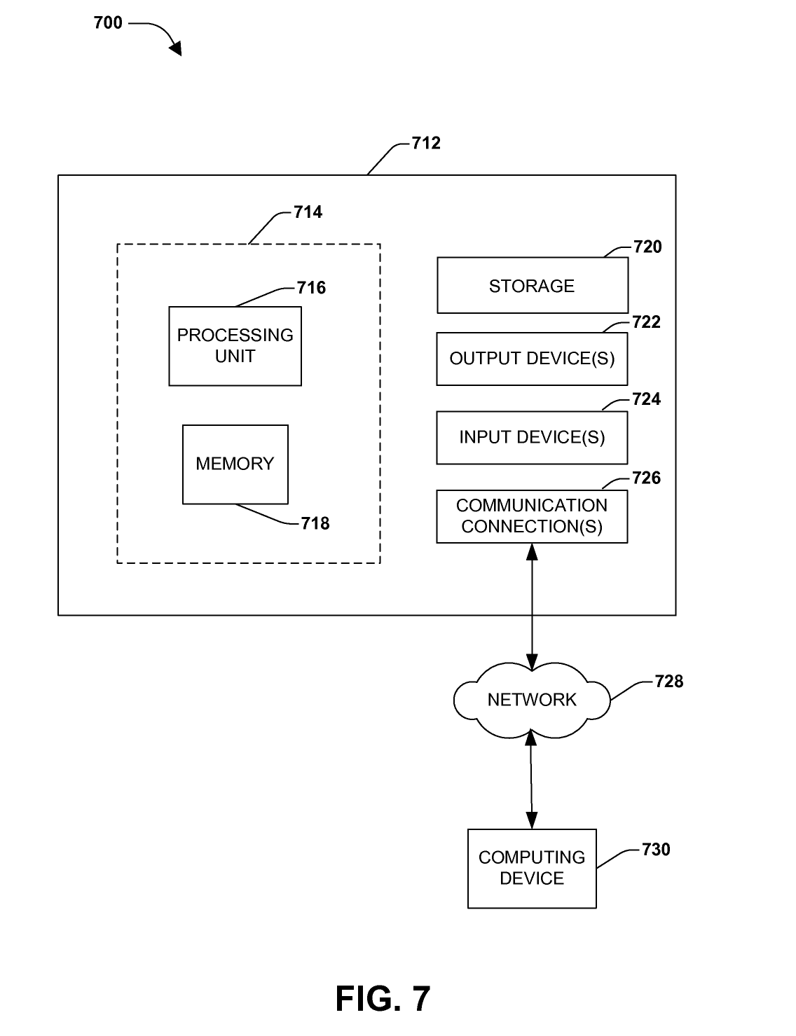

FIG. 7 and the following discussion provide a brief, general description of a suitable computing environment to implement embodiments of one or more of the provisions set forth herein. The operating environment of FIG. 7 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 7 illustrates an example of a system 700 comprising a computing device 712 configured to implement one or more embodiments provided herein. In one configuration, computing device 712 includes at least one processing unit 716 and memory 718. Depending on the exact configuration and type of computing device, memory 718 may be volatile (such as RAM, for example), non-volatile (such as ROM, flash memory, etc., for example) or some combination of the two. This configuration is illustrated in FIG. 7 by dashed line 714.

In other embodiments, device 712 may include additional features and/or functionality. For example, device 712 may also include additional storage (e.g., removable and/or non-removable) including, but not limited to, magnetic storage, optical storage, and the like. Such additional storage is illustrated in FIG. 7 by storage 720. In one embodiment, computer readable instructions to implement one or more embodiments provided herein may be in storage 720. Storage 720 may also store other computer readable instructions to implement an operating system, an application program, and the like. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 712. Computer storage media does not, however, include propagated signals. Rather, computer storage media excludes propagated signals. Any such computer storage media may be part of device 712.

Device 712 may also include communication connection(s) 726 that allows device 712 to communicate with other devices. Communication connection(s) 726 may include, but is not limited to, a modem, a Network Interface Card (NIC), an integrated network interface, a radio frequency transmitter/receiver, an infrared port, a USB connection, or other interfaces for connecting computing device 712 to other computing devices. Communication connection(s) 726 may include a wired connection or a wireless connection. Communication connection(s) 726 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 712 may include input device(s) 724 such as keyboard, mouse, pen, voice input device, touch input device, infrared cameras, video input devices, and/or any other input device. Output device(s) 722 such as one or more displays, speakers, printers, and/or any other output device may also be included in device 712. Input device(s) 724 and output device(s) 722 may be connected to device 712 via a wired connection, wireless connection, or any combination thereof. In one embodiment, an input device or an output device from another computing device may be used as input device(s) 724 or output device(s) 722 for computing device 712.

Components of computing device 712 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 712 may be interconnected by a network. For example, memory 718 may be comprised of multiple physical memory units located in different physical locations interconnected by a network.

Those skilled in the art will realize that storage devices utilized to store computer readable instructions may be distributed across a network. For example, a computing device 730 accessible via a network 728 may store computer readable instructions to implement one or more embodiments provided herein. Computing device 712 may access computing device 730 and download a part or all of the computer readable instructions for execution. Alternatively, computing device 712 may download pieces of the computer readable instructions, as needed, or some instructions may be executed at computing device 712 and some at computing device 730.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein. Also, it will be understood that not all operations are necessary in some embodiments.

Further, unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “exemplary” is used herein to mean serving as an example, instance, illustration, etc., and not necessarily as advantageous. As used herein, “or” is intended to mean an inclusive “or” rather than an exclusive “or”. In addition, “a” and “an” as used in this application are generally be construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

What is claimed is:

1. A method for generating an information interface based upon a user interest, comprising:
identifying a user signal associated with a user;
evaluating the user signal to determine a user interest of the user;
identifying a content provider that provides content associated with the user interest;
generating an information interface for the user interest; and
populating the information interface with the content from the content provider.

2. The method of claim 1, comprising:
identifying a second content provider that provides second content associated with the user interest; and
populating the information interface with the second content from the second content provider.

3. The method of claim 1, the user signal comprising at least one of:
a user selected field of a webpage;
a pre-generated information interface selected from a set of pre-generated information interfaces exposed for user browsing;
a search result pre-generated information interface selected from a set of search result pre-generated information interfaces; or
a search query suggestion pre-generated information interface selected from a set of search query suggestion pre-generated information interfaces.

4. The method of claim 1, the user signal comprising at least one of an email, a social network profile, a calendar entry, a message, a device location, user data stored on a user device, an app hosted by the user device, or a browsing history.

5. The method of claim 1, comprising:
exposing a configuration interface to the user;
receiving a user configuration for the information interface through the configuration interface; and
applying the user configuration to the information interface.

6. The method of claim 5, the user configuration comprising at least one of a category, a selected sample layout, a content update frequency, a location, or a user interface property.

7. The method of claim 1, the generating an information interface comprising:
exposing a set of pre-generated information interfaces to the user, a first pre-generated information interface associated with a first content type for the user interest and a second pre-generated information interface associated with a second content type for the user interest; and
receiving a selection of a pre-generated information interface from the set of pre-generated information interfaces.

8. The method of claim 1, comprising:
displaying the information interface through at least one of an operating system interface, an application, or a website.

9. The method of claim 1, comprising:
identifying a user selection of a field within a webpage;
determining a label for the field;
determining the user interest based upon the field; and
populating the information interface with content corresponding to the field, the content identified by the label.

10. The method of claim 9, the determining a label comprising at least one of:
evaluating content of the field to identify the label; or
receiving a user specified label for the field as the label.

11. The method of claim 1, comprising:
identifying a content update for the content provided by the content provider; and
updating the information interface based upon the content update.

12. The method of claim 1, comprising:
receiving a refresh request for the information interface;
evaluating a user interest to URL mapping to identify a webpage as the content provider for the user interest;
retrieving a current version of the webpage;
evaluating a field of the webpage to identify a content update for the information interface; and
updating the information interfaced based upon the content update.

13. The method of claim 1, comprising:
responsive to receiving a share request for the information interface from the user, sharing the information interface with a second user.

14. The method of claim 1, comprising:
receiving a shared information interface from a second user;
providing the user with a suggestion of the shared information interface; and
responsive to receiving a selection of the suggestion, generating a second information interface based upon the shared information interface.

15. The method of claim 1, comprising:
evaluating the user signal to identify a relationship between the user interest and a second user interest; and
populating the user interface with second content associated with the second user interest.

16. The method of claim 1, comprising:
selectively providing the information interface, but not a second information interface, to a first device of the user based upon a first device type of the first device; and
selectively providing the second information interface, but not the information interface, to a second device of the user based upon a second device type of the second device.

17. A system for generating an information interface based upon a user interest, comprising:
an interface management component configured to:
identify a user signal associated with a user;
evaluate the user signal to determine a user interest of the user;
identify a content provider that provides content associated with the user interest;
generate an information interface for the user interest; and
populate the information interface with the content from the content provider.

18. The system of claim 17, the interface management component configured to:
receive a refresh request for the information interface;
evaluate a user interest to URL mapping to identify a webpage as the content provider for the user interest;
retrieve a current version of the webpage;
evaluate a field of the webpage to identify a content update for the information interface; and
update the information interfaced based upon the content update.

19. The system of claim 17, the user signal comprising at least one of:
a user selected field of a webpage;
a pre-generated information interface selected from a set of pre-generated information interfaces exposed for user browsing;
a search result pre-generated information interface selected from a set of search result pre-generated information interfaces; or
a search query suggestion pre-generated information interface selected from a set of search query suggestion pre-generated information interfaces.

20. A computer readable medium comprising instructions which when executed perform a method for sharing an information interface, comprising:
receiving a shared information interface from a second user;
providing a user with a suggestion of the shared information interface;
responsive to receiving a selection of the suggestion, generating an information interface based upon the shared information interface;
populating the information interface with content from a content provider;
displaying the information interface to the user through at least one of an operating system interface or an app interface; and
responsive to identifying a content update for the content provided by the content provider, updating the information interface based upon the content update.
